(19) United States
(12) Patent Application Publication
(10) Pub. No.: US 2026/0141721 A1
(43) Pub. Date: May 21, 2026

(54) USING NEURAL NETWORKS TO DETERMINE PLACEMENT OF OBJECTS

(71) Applicant: Amazon Technologies, Inc., Seattle, WA (US)

(72) Inventors: Michael Robert Bocamazo, Framingham, MA (US); Siyao Hu, Grafton, MA (US); Vishal Kumar, Cambridge, MA (US); Frank Preiswerk, Brooklyn, NY (US); Timothy Stallman, Groton, MA (US); Gabrielle Toner, Nashville, TN (US)

(21) Appl. No.: 18/950,712

(22) Filed: Nov. 18, 2024

(51) Int. Cl. G06V 20/52; G06N 3/045; G06V 10/141; G06V 10/82

(52) U.S. Cl. CPC G06V 20/52; G06N 3/045; G06V 10/141; G06V 10/82

(57) ABSTRACT

Systems and methods are disclosed for identifying whether an object is stored within a container (e.g., tote). The system generates, using two or more neural networks, a plurality of predictions on whether the object is stored in a container. The two or more neural networks use two or more sets of images that are captured within different time frames to generate the plurality of predictions. Then, the system determines whether the object is stored in a container based, at least in part, on the plurality of predictions.

### BACKGROUND

In a busy fulfillment center, an associate can manually scan items from a container (e.g., box) and place them into designated containers (e.g., totes) for distribution. Sensors are positioned throughout the workspace to observe the operations. For example, a scale can be used to weigh items that an associate places in a container to estimate total weight of items in a container and use it a measure for when a container is full. Handling a high volume of items (e.g., hundreds, thousands, or more) can cause the associate to maintain both speed and accuracy. As the workload intensifies (e.g., more items, less time to store items), ensuring that each item is correctly placed becomes increasingly challenging. Despite sensor data (e.g., images) being collected, the associate does not receive immediate feedback, verification, or other information when an item is placed in the wrong container. As the associate continues working without real-time confirmation, errors can occur unnoticed, potentially impacting the efficiency of the distribution process.

### BRIEF DESCRIPTION OF THE DRAWINGS

Various techniques will be described with reference to the drawings, in which:

FIG. 1 illustrates a system to place items in a location within an environment or move the items within the environment, according to at least one embodiment;

FIG. 2 illustrates a system to control sensors and lighting, according to at least one embodiment;

FIG. 3 illustrates a system to capture items using different sensors, according to at least one embodiment;

FIG. 4 illustrates a system to determine whether the items are placed in a location within an environment, according to at least one embodiment;

FIG. 5 illustrates a system to train neural networks, according to at least one embodiment;

FIG. 6 illustrates a process to place items in a location within an environment or move the items within the environment, according to at least one embodiment;

FIG. 7 illustrates a process to determine whether the items are placed in a location within an environment, according to at least one embodiment; and

FIG. 8 illustrates a system in which various embodiments can be implemented.

### DETAILED DESCRIPTION

Systems and methods are described herein for item or object tracking using artificial intelligence (e.g., neural networks, machine learning). A system in an environment (e.g., a facility, shipping warehouse, fulfillment center, etc.) includes a station and a computer system (e.g., one or more processors) that performs operations so that some tasks (e.g., unpackaging items, scanning items, sorting items, storing items, repackaging items, shipping items, etc.) can be performed at the station. For example, an item within a box may arrive at a station to be unpackaged and scanned (e.g., to be identified) before being placed in one of the totes. The computing system can use computer-vision software to process data from various sensors that are positioned around, attached to, or otherwise configured to monitor the station.

The station can include a receiving substation configured to receive items packaged in a box. Sensors associated with the receiving substation can capture images of the box and send them to a neural network (e.g., Convolutional Neural Networks (CNN)) that identifies identifiers (e.g., barcodes, labels, QR codes, etc.) associated with the box. The computing system can automatically use the identifiers to obtain information corresponding to the box, such as the number and type of items within the box, dimensions of the box, dimensions of the items, weight of the items, make of the items, or other metadata related to the box or items within the box. As a result, an associate at the station in a distribution center may not need to manually use a scanner (e.g., hand scanner) to read box identifiers, as the computing system can automatically recognize metadata about the items, allowing the associate to perform their tasks hands-free. Sensors (e.g., cameras, LiDAR, etc.) can be positioned in the environment and/or around the station to monitor and capture sensor data from the area surrounding the receiving substation.

The station may further include a scanning substation configured to automatically scan the items as they are unpackaged from the box and transferred into totes located on a sorting substation. Sensors (e.g., cameras, LiDAR, etc.) can be positioned in the environment and/or around the station to monitor and capture sensor data from the area surrounding the scanning substation. The sensors can capture images of the items to be scanned and send them to the neural network that identifies identifiers (e.g., one-dimensional (1D) barcodes such as linear barcodes, two-dimensional (2D) barcodes such as QR codes, other 2D codes such as DataMatrix code, PDF417, or Aztec code, or other dimensional barcodes such as 3D barcodes, also known as Bumpy Barcodes, etc.) associated with the items. The associate may manipulate (e.g., rotate, flip, move, etc.) the items so that they can be captured at different angles, viewpoints, or in different positions. The neural network, performed by processors of the computing system, may include components that identify the manipulated items among other items and detect the identifiers of the items within the images. The computing system can use the identifiers to obtain information about the items, such as their quantity, type, dimensions, weight, and any special handling instructions (e.g., place them in a particular tote). As a result, an associate at a distribution center with the station may not need to use a scanner (e.g., hand scanner) to read the identifiers of the items.

In some examples, different substations of the station may orient the sensors in various directions and/or have different fields of view (FoV). The different FoV that corresponds to the sensors may at least partially overlap with one another's FoV. Each sensor can correspond with a lighting element that illuminates the items, totes, boxes, and/or surroundings to ensure lighting conditions (e.g., brightness, illumination, contrast) meet a threshold for capturing images, such as being sufficiently bright to scan a barcode or enable identification through computer vision. In one example, a primary sensor may control other sensors within the station, enabling coordinated or synchronized lighting. The computing system may include a controller that manages the sensors within the station to synchronize lighting conditions. The lighting elements may include ring lights positioned around the sensors. Moreover, baffles can be used to reduce straying of light emitted via the lighting elements. For example, the baffles may prevent the light from shining directly (or too brightly) into the eyes of the associate working at the station. The baffles may be disposed in front of the lighting elements to reduce light intensity (e.g., block it, refract it, or reflect it). Shields, deflectors, and the like, in addition to or as an alternative to the baffles, may be used to prevent light glaring into the eyes of the associate.

In various examples, the computing system can dynamically adjust (e.g., based on sensed light conditions) the intensity, frequency, or temperature of the light emitted by the lighting elements to enhance the quality of images captured by the sensors, while also ensuring the safety and comfort of the associates working at the station. For example, adjusted lighting conditions may reduce glare and improve visibility in low-light environments, resulting in clearer, more detailed images. In other examples, adjusted lighting conditions can balance light and shadow, enhancing details and producing sharper, more vibrant images. Also, controlled lighting may highlight items, boxes, and totes that are manipulated by associates working at the station. The computing system may use the physical design and placement of the baffles and lighting elements, as well as their positioning relative to the associates, as inputs to an algorithm or neural network to generate an adjustment (e.g., to adjust the light's intensity, frequency, or temperature). The computing system may include a processor to cause a primary sensor, referred to as the leading sensor, to adjust its associated lighting element. In response to these changes for the leading sensor, the lighting elements for other sensors will adjust accordingly (e.g., by a controller sending instructions to these secondary lighting elements). The leading sensor can coordinate the light's intensity, frequency, or temperature, ensuring that the other lighting elements at the station emit synchronized lighting conditions for (e.g., optimal) performance.

The station may further include a sorting substation configured to determine whether the items are properly placed into a particular tote of a group of totes that are located within the sorting substation. Properly placing items into totes may include selecting the correct tote or a group of totes based on the item's identifier, arranging items to maximize the space efficiency of each tote, grouping similar items in the same tote, and positioning fragile items in protective placements to prevent damage. Once the identifiers of the items are identified, the associate may place the items into at least one of the totes that reside on the sorting substation. The totes may include bins, tubs, or any suitable container. The sorting substation may include dividers that are located between adjacent totes.

In some examples, sensors (e.g., cameras, LiDAR, etc.) can be positioned in the environment and/or around the station to monitor and capture sensor data from the area surrounding the sorting substation. The sensors associated with the sorting substation can capture images of the items moving towards the totes. The sensors may capture the items as the items are deposited into the totes. The sensors may capture identifiers of the totes, which can be used by neural networks to determine which totes are within the sorting substation. The set of images generated by the sensors is sent to different neural networks that generate predictions on whether the items are properly stored within the particular tote. To increase the processing speed and accuracy for the neural networks described herein, the computing system may convert the red, green, and blue (RGB) images to monochrome images and add time information in a separate channel. The computing system may increase the number of channels of the RGB images by adding time series information. The computer system can mix time information into the same channel used for the color values.

The computing system can perform one of the neural networks (e.g., CNN) to determine whether the item is properly placed based on a series of scenes captured within images generated over a short time window (e.g., seven frames). The computing system can determine whether the images are generated within the short time window, enabling the neural network to generate predictions within a certain time frame. The neural network can be trained using a set of rules or ground truth labels that indicate negative stow events, where the events may refer to items being misplaced, improperly oriented, or exceeding the tote's capacity. The computing system may pre-process the images such that temporal information can be included in the images for inferencing.

The computing system can perform another neural network (e.g., transformer neural network, recurrent neural network (RNN), etc.) to determine whether the item is properly placed based on a series of scenes captured within images generated over a long time window. The neural network may receive images captured by sensors associated with the receiving substation, the scanning substation, and the sorting substation to obtain contextual information about the movement of the item, such as its removal from the box to its placement in one of the totes. The neural network may receive images generated for previous items to identify additional context. The neural network can use images obtained over a long time window to store context that is usable for generating the determination.

The computing system may include a function that uses the predictions generated by the different neural networks to determine whether the items are properly stored in a tote within the sorting substation. The determination may further include determining which tote the item is deposited in. The computing system may cause the lighting elements of the sorting substation or the station's display to indicate whether the items are properly stored or if there is an issue associated with the items.

In some examples, the sorting substation may include a fullness measurement mechanism to detect if the tote is too full, for example, above the top of the tote. The fullness mechanism may include a code or a bar that resides above the tote. The sensors associated with the sorting substation may capture that the items within the totes extend beyond the top of the tote. A logic or a neural network can be used by the computing system to determine whether a certain tote has met a threshold to be removed for further distribution. The computing system may use other information such as weights to control the fill of the totes. For example, the computing system can accumulate the item's weight (retrieved from the item's identifier) to calculate the total weight of the tote with the item. As the totes within the sorting substation become full, the associate may move the tote onto a conveyor that transports the tote to other locations, stations, etc. within the environment for sorting, packaging, order fulfillment, etc. The sorting substation may include lighting elements that indicate the status of each tote. For example, one indication may indicate that a tote can accept items, and another indication may indicate that a tote cannot accept items.

The station may be used to conveniently remove items from their boxes and place the items into the totes that allow automated storage systems to move the totes throughout the environment to pickers and robotic devices for order fulfillment. As such, the station may increase the throughput of items being inducted, may be conveniently operated by associates, and/or may reduce errors associated with inducting items.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure including two or more neural networks to track one or more items or any other objects included in a set of images, certain embodiments may be capable of achieving certain advantages, including some or all of the following: (1) optimal use of sensor data (e.g., images), (2) reduced memory requirement caused by efficient inventory management, (3) real-time feedback reducing latency in information processing, (4) enhanced accuracy of the systems performing computer vision technologies, (5) intuitive and effective user interfaces (e.g., within stations), (6) advancing interoperability between devices (e.g., sensors), etc.

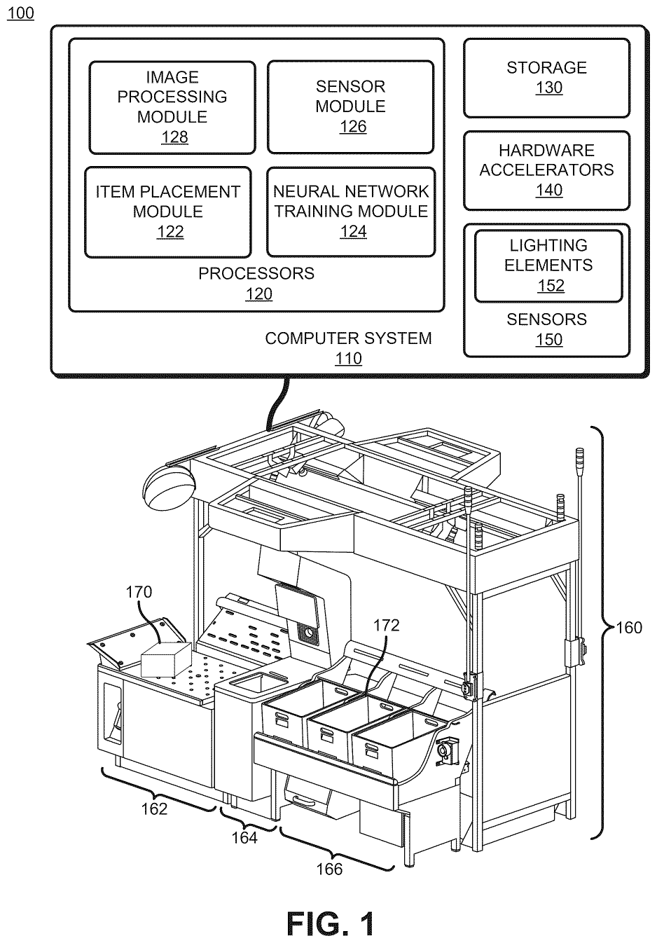

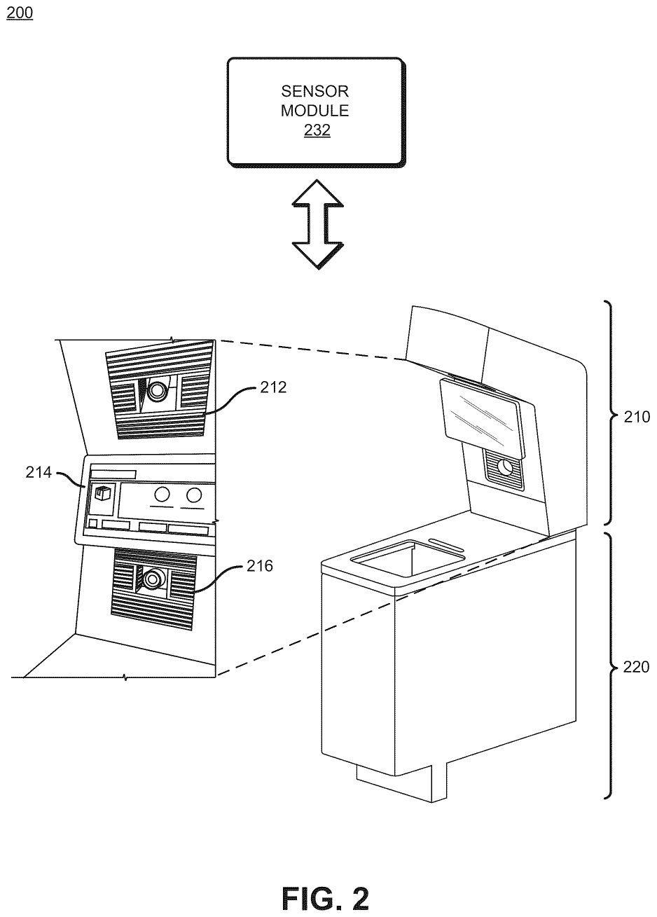

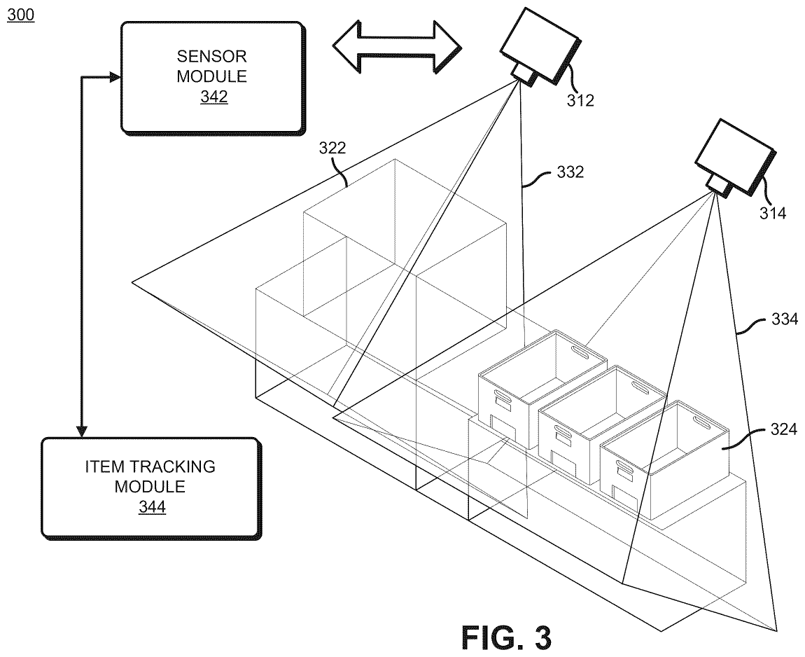

FIG. 1 illustrates system 100 to place items in a location within an environment or move the items within the environment. System 100 may comprise one or more of the hardware and software described herein to manage the tracking of items within a distribution center. System 100 can be part of the distribution center, which may refer to a partially or fully automated facility where goods are received, stored, and organized for efficient redistribution to retailers, customers, or other locations in the supply chain. System 100 may include computer system 110 and station 160. System 100 may include system 200 illustrated in FIG. 2. System 100 may include system 300 illustrated in FIG. 3.

In at least one embodiment, computer system 110 may include one or more processors 120, storage 130, one or more hardware accelerators 140, and one or more sensors 150. In at least one embodiment, computer system 110 may serve as an edge device physically integrated with station 160 to execute various functionalities (e.g., computer vision, artificial intelligence) as described herein. In some examples, computer system 100 may be cloud-based and connected through various types of network communication (e.g., wireless, wired, or cellular). In various examples, one or more components of system 110 may be physically integrated with station 160, while other components may be cloud-based and connected via network communication. For example, sensor module 126 and one or more sensors 150 may be part of station 160, while other components of computer system 110 (e.g., item placement module 112, neural network training module 124, image processing module 128) can reside in the cloud.

In at least one embodiment, one or more processors 120 may refer to one or more central processing units (CPU) or any other general-purpose processors. One or more processors 120 may include item placement module 122, neural network training module 124, sensor module 126, and image processing module 128. One or more processors 120 may run software to provide functionality described herein.

In at least one embodiment, terms such as “software” described herein may include one or more of the following: operating systems, device drivers, application software, database software, graphics software, web browsers, development software (e.g., integrated development environments, code editors, compilers, interpreters, etc.), network software, simulation software, real-time operating systems (RTOS), artificial intelligence software, robotics software, firmware (e.g., BIOS/UEFI, router, smartphone, consumer electronics, embedded systems, printer, solid state drive (SSD), etc.), APIs, containerized software, container orchestration platforms, algorithms, instructions, and any other implementation embedded as a software package, code, and/or instruction set.

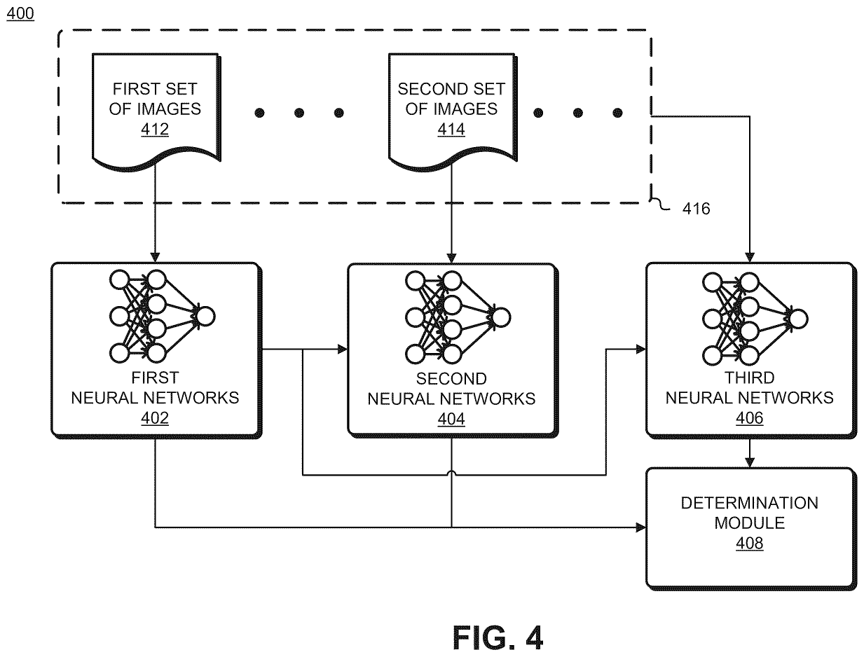

In at least one embodiment, terms such as “hardware” described herein may include one or more components of station 160, one or more processors 120, one or more hardware processors 140, and one or more sensors 150. The “hardware” may further include hardwired circuitry, programmable circuitry, state machine circuitry, fixed function circuitry, execution unit circuitry, and/or firmware that stores instructions executed by programmable circuitry. As used in any implementation described herein, unless otherwise clear from context or stated explicitly to the contrary, terms such as “module” and nominalized verbs (e.g., item placement module 122, neural network training module 124, sensor module 126, image processing module 128, sensor module 232 illustrated in FIG. 2, sensor module 342 and item tracking module 344 illustrated in FIG. 3, determination module 408 illustrated in FIG. 4, etc.) illustrated in at least FIGS. 1-4 each refer to any combination of software and/or hardware configured to provide specific functionality.

In at least one embodiment, item placement module 122 may refer to a module that determines whether an item from box 170 was placed in correct tote 172 within station 160. Item placement module 122 causes sensor module 126 to coordinate one or more sensors 150 located in first substation 162, second substation 164, and third substation 166 of station 160 to track the movement of the item from box 170 to correct tote. A set of images generated by one or more sensors 150 may include the movement of box 170, items, and tote 172 to track how the items are placed into tote 172.

Item placement module 122 uses a plurality of neural networks trained by neural network training module 124 for different tasks. For example, item placement module 122 may use a first neural network (e.g., one or more first neural networks 402 illustrated in FIG. 4) to identify identifiers of boxes 170, items, and totes 172 using the set of images. The first neural network may indicate a location of those identifiers included in the set of images. The first neural network may include or be connected to a decoder (e.g., barcode decoder) capable of reading the identifier once it has been detected. The identifiers are used to extract information associated with boxes 170, items, and totes 172. The information can be used to determine which totes (individual, group) that the items should be stored.

In some examples, item placement module 122 may use a second neural network (e.g., one or more second neural networks 404 illustrated in FIG. 4) to determine whether an item is properly placed in a tote using the set of images. The second neural network may use a few frames (e.g., seven frames) to ensure that it generates predictions fast enough. The short number of frames may focus on scenes that include an item entering the tote or an item moving near the tote. Item placement module 122 may cause one or more lighting elements located in third substation 166 to indicate a negative stow to the associate.

In various examples, item placement module 122 may use a third neural network (e.g., one or more third neural networks 406 illustrated in FIG. 4) to determine whether an item is properly placed in a tote using the set of images. The third neural network may use a large number of frames to provide more comprehensive feedback or indication to the associate. The large number of frames may include images that were captured from unpacking the item from box 170 to placing the box to tote 172. The large number of frames includes all of the set of images. Item placement module 122 may include an orchestration function or a reasoning function that receives predictions generated from the second neural network and the third neural network to confirm whether the item is properly placed in a tote using the set of images. As a result, the associate does not have to manually scan the item that is out from box 170 and manually enter information into station 160 to associate the item with tote 172. Item placement module 122 may include item tracking module 344 illustrated in FIG. 3 and determination module 408 illustrated in FIG. 4.

In at least one embodiment, neural network training module 124 may refer to a module that manages the learning process of neural networks (e.g., one or more first neural networks 402, one or more second neural networks 404, one or more third neural networks 406 illustrated in FIG. 4). Neural network training module 124 may work with the neural network architecture and the dataset, coordinating the flow of data through the network during training. Neural network training module 124 may performs the core processes of forward propagation, where input data is passed through the network to generate predictions, and backward propagation, where gradients are computed based on the loss function to update the neural network's weights. Neural network training module 124 may orchestrate the training loop over a specified number of epochs and batches to cause each data point to contribute to the neural network's learning.

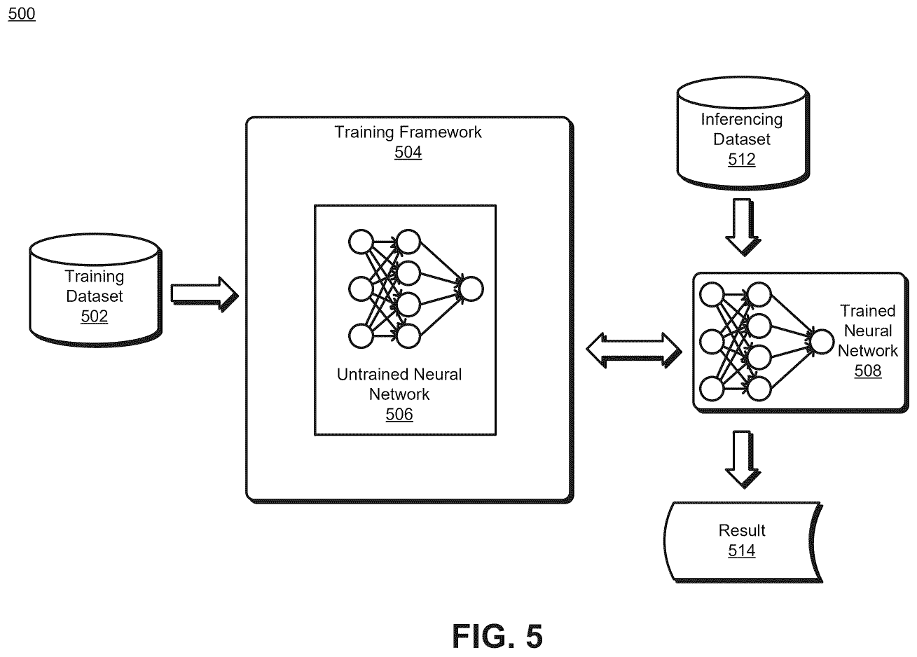

Neural network training module 124 may manage optimization algorithms (e.g., Stochastic Gradient Descent, Adam, RMSprop) that adjust the network's parameters to minimize the loss function. Neural network training module 124 may calculate the loss by comparing the network's predictions with the actual target values using appropriate loss functions (such as cross-entropy for classification or mean squared error for regression). Neural network training module 124 may perform tasks like shuffling and batching of data, learning rate scheduling, and applying regularization techniques (such as dropout or weight decay) to prevent overfitting. Neural network training module 124 may monitor training progress by tracking metrics like loss and accuracy, and network training module 124 may save and load neural network checkpoints to resume training or for future inference. In at least one embodiment, neural network training module 124 may include training framework 504 illustrated in FIG. 5.

In at least one embodiment, one or more neural networks described herein (e.g., one or more first neural networks 402, one or more second neural networks 404, one or more neural networks 406) may refer to a computational model comprising interconnected nodes (neurons) configured to process input data, identify patterns, and generate outputs based on learned relationships between the data. In at least one embodiment, the one or more neural networks may comprise one or more parameters (e.g., one or more weights, one or more biases). In at least one embodiment, the one or more neural networks may comprise one or more graph codes that define an architecture (e.g., how input and output of individual neurons of the one or more neural network flows) of the one or more neural networks. In at least one embodiment, graph code may refer to a method of organizing computations where tasks are represented as nodes in a graph, and their dependencies can be represented as edges, such that independent tasks can be run in parallel using, for example, one or more hardware accelerators 140.

In at least one embodiment, sensor module 126 may refer to a module that controls one or more sensors 150 and one or more lighting elements. One or more sensors 150 may refer to a device or component that detects, measures, and responds to physical, chemical, or environmental changes—such as temperature, pressure, motion, light, sound, or proximity—and converts this information into signals or data that can be interpreted by sensor module 126. One or more sensors 150 may include cameras, color sensors, infrared proximity sensors, LiDAR, etc. One or more sensors 150 may include one or more lighting elements 152. One or more lighting elements 152 may refer to components such as light panels, LED lights, flashlights, or ring lights that are attached to one or more sensors 150 to provide additional illumination. One or more lighting elements 152 can enhance image quality by improving lighting in low-light conditions, reducing shadows, and ensuring the subject is well-lit for clearer, sharper photos or videos.

In at least one embodiment, sensor module 126 may control one or more sensors 150 to receive sensor data, such as a set of images (e.g., first set of images 412, second set of images 414, third set of images 416 illustrated in FIG. 4) that include one or more boxes 170, one or more items, and/or one or more totes 172 that are within station 160. Specifically, the set of images may capture unpackaging of one or more items from one or more boxes 170 in first substation 162, manipulation of the one or more items in second substation 164 for scanning, and placement of the one or more items in a particular tote 172 in third substation 166. The set of images may include one or more items, boxes 170, and/or totes 172, captured from different viewpoints using one or more sensors 150 positioned at various angles. The set of images may provide a more comprehensive view of the one or more items, boxes 170, and/or totes 172.

In some examples, sensor module 126 may control strobing lights emitted from one or more lighting elements 152 to improve the quality of sensor data captured by one or more sensors 150 while improving the comfort of associates working at station 160 with strobing lights. Strobing lights may refer to lighting sources that emit rapid, repetitive bursts of light, creating a flickering or pulsating effect. This effect can often be intentional, such as in strobe lights used for visual effects in entertainment venues, emergency vehicles, or alarm systems, where the flashing is meant to capture attention. Sensor module 126 may identify a strobing frequency (e.g., 150 Hz to 1200 Hz) to avoid discomfort among associates. Sensor module 126 may identify a wavelength of the light (e.g., color of the light, such as white light) to avoid discomfort (e.g., comfort risk related to invisible flicker) among associates. Sensor module 126 may adjust the lighting conditions based on the associate's sensitivity to different light colors, strobing frequencies, and duty cycles. Sensor module 126 may include sensor module 232 illustrated in FIG. 2 and sensor module 342 illustrated in FIG. 3.

In various examples, sensor module 126 may perform synchronized strobing (e.g., globally synchronized such that all strobe lights are synchronized to strobe in unison). This may include causing lighting elements 152, which are located within and/or aimed or positioned to illuminate station 160, to strobe concurrently or simultaneously. This synchronization can allow sensors 150 to capture sensor data that is aligned with the strobes, providing additional illumination based on the specific angles at which the sensors 150 and lighting elements 152 are positioned relative to each other and to station 160. In various examples, lighting elements can strobe within a frequency range of 150 to 1200 Hz. Strobing lights can be intense, with over 90% modulation, where this percentage indicates how dark the light becomes compared to moments when it is at maximum brightness. In synchronized strobing, sensor module 126 coordinates with lighting elements 152 to pulse at this frequency, ensuring consistent illumination across an area of interest. In at least one embodiment, the system balances power efficiency with illumination needs, allowing sensors 150 to capture data effectively without excessive power usage or disruptive visual flicker in the warehouse, while additionally not causing eye strain.

In other examples, sensor module 126 may perform uniform phase offset strobing, which includes causing lighting elements 152 to strobe at the same frequency but with a uniform phase offset between them. A uniform phase offset may refer to each lighting element 152 starting its cycle at a different point in time, but the time difference (or phase offset) between the start of each cycle is the same for all lights. One or more sensors 150 can be paired with one or more lighting elements 152 that pulse during capture. Uniform phase offset strobing may also include causing lighting elements 152 to strobe at approximately 1/N the frequency of the equivalent globally synchronized strobing pattern, where N is the number of lights. For instance, if there are four lighting elements 152 corresponding to four sensors 150 located within and/or aimed or positioned to illuminate station 160, having the four lighting elements 152 pulse at 200 Hz (with uniform phase offset and similar intensity) can result in the scene being illuminated with pulses at an overall frequency of 800 Hz. Sensor module 126 may determine the frequency and intervals at which each lighting element 152 operates based on the specific locations or positions of each lighting element 152. Consequently, performing uniform phase offset strobing may reduce invisible flickering and improves user comfort by ensuring that the intervals between the pulses are consistent and tailored to the spatial arrangement of the lighting elements.

In at least one embodiment, image processing module 128 may refer to a module that that generates and preprocesses (e.g., denoises, downsamples, upsamples, or otherwise modifies) images usable by item placement module 122 and neural network training module 124. Image processing module 128 may receive one or more images or frames from sensor module 126. Image processing module 128 may modify those images or frames. Modification of images may include, for example, resizing, cropping, normalization (e.g., scaling intensity values, etc.), augmentation (e.g., rotation, flipping, zooming, shifting, other affine transforms, tec.), redistribution of intensity values (e.g., histogram equalization), denoising, enhancement (e.g., adjusting brightness, contrast, sharpness, etc.), color space conversion, filtering (e.g., Laplacian, Sobel, Gaussian blur, etc.), image alignment, scaling (e.g., deep learning super-sampling (DLSS), Xe super-sampling (XeSS), AMD FidelityFX Super Resolution (FSR), etc.), and/or anti-aliasing (e.g., multi-sample anti-aliasing (MSAA), fast approximate anti-aliasing (FXAA), temporal anti-aliasing (TAA), super-sampling anti-aliasing (SSAA), conservative morphological anti-aliasing (CMAA), etc.).

In at least one embodiment, image processing module 128 may generate or modify neural network training data that can be used by neural network training module 124. For example, image processing module 128 may generate labels for supervised learning or generate partially labeled data for semi-supervised learning of neural networks. Image processing module 128 may receive indications of ground truth to generate those labels. Image processing module 128 may increase the number of channels of image data by adding time series information to the image data. Image processing module 128 may transform information within one or more channels of image data (e.g., converting RGB data to time series data, etc.).

In at least one embodiment, storage 130 may refer to one or more hardware and software components described herein to store, retrieve, and manage data, allowing information to be saved and accessed by one or more entities (e.g., computer system 110, one or more processors 120, item tracking module 122, neural network training module 124, sensor module 126, storage 130, one or more hardware accelerators 140, one or more sensors 150, one or more lighting elements 152, etc.). The storage may include one or more of random access memory (RAM), read-only memory (ROM), flash memory (e.g., Universal Serial Bus (USB) flash drives, SSD, memory cards, etc.), cache memory, hard disk drives (HDDs), virtual memory, graphics memory, optical discs, network-attached storage (NAS), cloud storage, tape storage, etc. Additionally, the storage may further include one or more of relational databases, NoSQL databases, key-value stores, document-oriented databases, column-family stores, and graph databases. In addition, the storage may also include one or more of code repositories, artifact repositories, content repositories, document repositories, package repositories, etc. Furthermore, the storage may include one or more of file storage (e.g., network-attached storage (NAS), cloud storage service, etc.), block storage, object storage, cache storage, tape storage, etc.

In some examples, storage 130 may store sensor data (e.g., set of images described herein, etc.) generated by one or more sensors 150. Storage 130 may store modified sensor data (e.g., monochrome images described herein). Storage 130 may store information (e.g., identifier, tracking number, contents of the box, receiver information, date of time of entry, weight and dimensions, priority level, etc.) associated with boxes 170 containing specific items that enter station 160. Storage 130 may store information (e.g., item description, stock keeping unit, manufacturer information, expiration date, serial number, pricing information, handling requirements, supplier information, etc.) associated with items that are within boxes 170. Storage 130 may store neural network training data (e.g., images with ground truth labels) to train one or more neural networks described herein. Storage 130 may store information (e.g., size and dimensions, status, labels) related to totes designated for holding the items. Storage 130 may store data structures representing the association between totes and the items they contain. The data structures may include, for example, arrays, linked lists, stacks, queues, trees, hash tables, graphs, heaps, sets, etc.

In at least one embodiment, one or more hardware accelerators 140 may refer to one or more of specialized hardware units designed to perform specific tasks more efficiently than a general-purpose processor. Hardware accelerators include one or more of integrated circuit (IC), system on-chip (SoC), graphics processing unit (GPU), data processing unit (DPU), digital signal processor (DSP), tensor processing unit (TPU), accelerated processing unit (APU), application-specific integrated circuits (ASIC), intelligent processing unit (IPU), neural processing unit (NPU), smart network interface controller (SmartNIC), vision processing unit (VPU), field-programmable gate array (FPGA), etc.

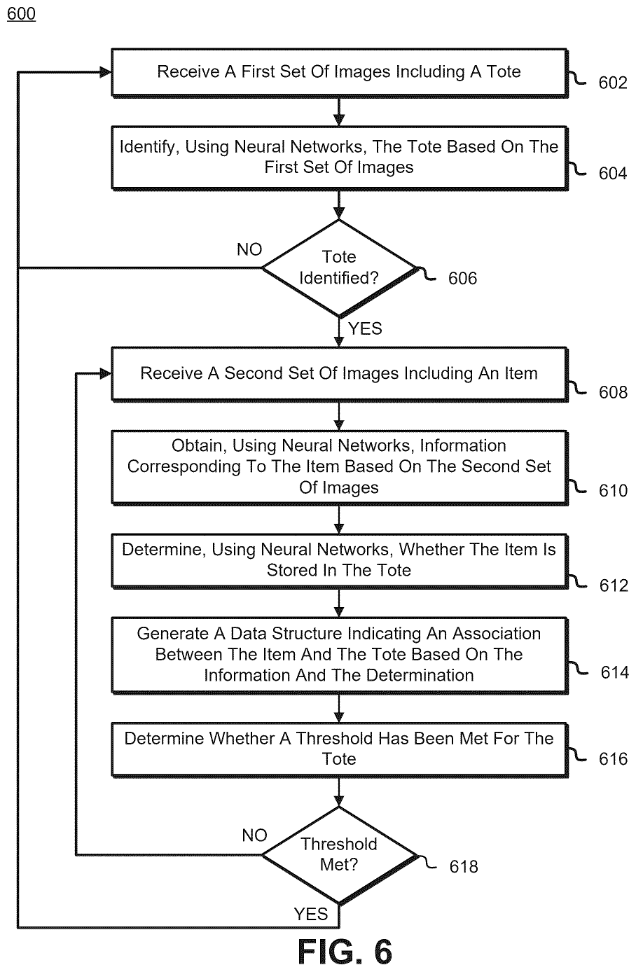

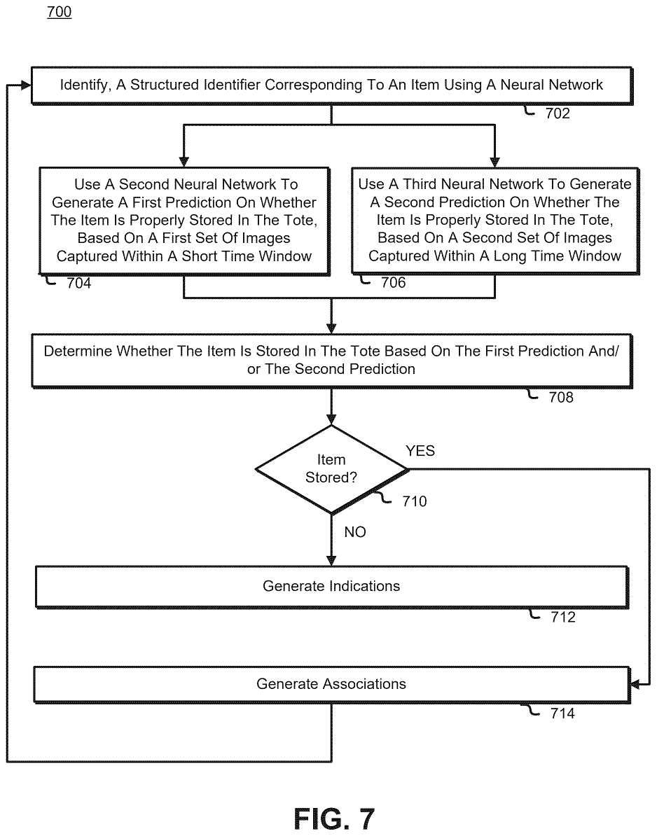

The specific tasks performed by one or more hardware accelerators 140 may include neural network inferencing and training. Item tracking module 122 and/or the neural network training module 124 utilize one or more hardware accelerators 140 for these tasks. For example, neural network inferencing may include image classification, object detection, image segmentation (e.g., semantic segmentation, instance segmentation), image super-resolution, image synthesis and generation, style transfer, etc. Additionally, one or more hardware accelerators 140 accelerate the performance of one or more blocks of process 600 and/or process 700 illustrated in FIGS. 6 and 7. One or more hardware accelerators 140 may accelerate one or more operations performed by station 160. Also, one or more hardware accelerators 140 may accelerate image generation and modification process performed by image processing module 128.

In at least one embodiment, station 160 may refer to a designated workspace in a distribution center where an associate, aided by sensors, cameras, and computer systems, unpacks, scans, and organizes items into totes for distribution, with technology assisting in tracking and ensuring accuracy throughout the process. The associate may retrieve one or more boxes 170, such as packages, cases, cartons, bins, containers, etc. and maneuver one or more boxes 170 onto first substation 162. One or more boxes 170 may be made of corrugate, plastic, etc. In some instances, one or more boxes 170 may be transferred to first substation 162 one by one, or more than one box may reside on first substation 162. One or more boxes 170 may arrive at station 160 via one or more of conveyors, chutes, robotic elements, etc.

One or more boxes 170 may include one or more items that are to be inducted, or otherwise decanted, into the environment for storage, inventory, distribution, order fulfillment, etc. One or more boxes 170 may contain any number of items (e.g., one, three, ten, etc.), and one or more boxes 170 may include any type of item (e.g., electronics, household goods, widgets, clothing, etc.). In some instances, the one or more items may be individually packaged, such as within plastic wrap, boxes, etc. At first substation 162, one or more boxes 170 may be opened (e.g., using a box cutter, etc.) to reveal the one or more items and permit the one or more items to be sorted from one or more boxes 170 to one or more totes 172 located at third substation 166.

One or more boxes 170 may include identifiers (e.g., barcode) that are read (e.g., scanned, imaged, etc.) by one or more sensors 150 of first substation 162 and/or the station 100 for determining contents of one or more boxes 170. For example, sensor data (e.g. a set of images) generated by one or more sensors 150 may be used by item placement module 122 to determine details of the one or more items contained in one or more boxes 170, such as a quantity of the one or more items, a type of the one or more items, a weight of the one or more items, etc. without a need for the associate to use a separate barcode reader.

In at least one embodiment, one or more sensors 150 may be disposed overhead of the first substation 162 and/or a frame of the station 160. One or more sensors 150 may be oriented towards first substation 162 and one or more boxes 170 contained on first substation 162. Any number of one or more sensors 150 may be used to read one or more boxes 170 and one or more sensors 150 may have different FoVs. The associate working at station 160 may manipulate (e.g., rotate, flip, etc.) one or more boxes 170 for enabling item placement module 122 to use one or more sensors 150 to read the identifier on one or more boxes 170. Additionally, one or more lighting elements 152 may assist in illuminating portions of first substation 162 and/or one or more boxes 170 for allowing one or more sensors 150 to read the identifier. One or more lighting elements 152 can be disposed on first substation 162 and/or the frame of the station 160. In some examples, baffles, deflectors, etc. may be disposed adjacent to one or more lighting elements 152 to reduce glare experienced by the associate. A material or surface finish of the baffles may also serve to reduce the glare.

As the associate retrieves the one or more items from one or more boxes 170, the associate may move the one or more items to second substation 164. Second substation 164 may include one or more sensors 150 usable by item placement module 122 to read a barcode, label, identifier, etc. on the one or more items. In some examples, one or more items may include a respective barcode for being read by one or more sensors 150 of second substation 164. The associate may manipulate the one or more items across second substation 164 for being captured by one or more sensors 150.

In at least one embodiment, second substation 164 may include four sensors, where the four sensors may be oriented in different directions and/or have different FoV to successfully capture the barcode on the one or more items. For example, a first sensor may be oriented in a first direction and have a first FoV, a second sensor may be oriented in a second direction, different than the first direction, and a have a second FoV, a third sensor may have be oriented in a third direction, different than the second direction, and have a third FoV, and a fourth sensor may be oriented in a fourth direction, different than the third direction, and have a fourth FoV. In some examples, the first FoV, the second FoV, the third FoV, and the fourth FoV may at least partially overlap with one another.

In at least one embodiment, second substation 164 may include the one or more lighting elements that illuminate the one or more items to permit one or more sensors 150 to capture the barcode. For example, the one or more lighting elements may illuminate the FoVs of one or more sensors 150. The one or more lighting elements may represent ring lighting elements disposed around one or more sensors 150. Moreover, baffles may be used to reduce straying of light emitted via one or more lighting elements. For example, the baffles may prevent the light being glared into eyes of the associate working at station 160. Shields, deflectors, and the like, in addition or alternative from the baffles, may be used.

In at least one embodiment, second substation 164 may include a display that displays information associated with the one or more items being scanned by item placement module 122. The information may include a type of item, an identifier of the item, characteristics of the item, such as weight, material, size, etc. The display may also display indications of one or more totes 172, and the relative fill volume, percentage, weight, etc. of the one or more totes 172. The indications may include a selection of a tote among one or more totes 172. Alternatively, the indication may include a selection a group of totes among a larger group of totes 172 that corresponds to the items to be stored.

Once the one or more items are identified by item placement module 122 using one or more neural networks, the associate may place the one or more items into one or more totes 172 that resides on/within third substation 166. In some examples, the one or more items from one or more box 170 may be placed in the same tote or different tote of one or more totes 172. One or more totes 172 may represent any suitable container, bin, tub, etc. into which the one or more items are placed. One or more totes 172 may arrive at the station 160 via any suitable manner and the associate may stock the one or more totes 172 (e.g., when totes become full and need replacement). In some examples, the associate may stock one or more totes 172 manually, or other entities (e.g., via robotic elements, end effectors, etc.) may automatically restock one or more totes 172.

In at least one embodiment, third substation 166 can be configured to hold, store, or receive one or more totes 172. For example, third substation 166 may receive three totes. Each of one or more totes 172 may be received in a tote slot. Dividers, partitions, etc. may separate each of one or more totes 172, between the tote slots.

One or more totes 172 may also have an identifier that may be identified by item placement module 122 using one or more sensors 150 of third substation 166. Moreover, the identifier of one or more totes 172 may be used to associate certain items with a tote of one or more totes 172. The association may allow for a weight of one or more totes 172 to be known, a fill volume of one or more totes 172 to be known, and what item are deposited into the one or more totes 172 to be known. In some instances, one or more sensors 150 may be disposed on the frame, overhead of third substation 166, oriented in a direction towards one or more totes 172, and/or on third substation 166.

In at least one embodiment, third substation 166 may include one or more lighting elements 152 to illuminate, third substation 166, such as one or more totes 172, identifiers on one or more totes 172, and so forth. The illumination may permit or assist one or more sensors 150 to capture one or more totes 172 and the one or more items stored in one or more totes 172. Third substation 166 may include additional lighting elements that output indications associated with a state of one or more totes 172 and/or third substation 166. For example, the additional lighting elements may output a first indication when one or more totes 172 are present and ready to be filled, and may output a second indication when one or more totes 172 are absent or full. Each of the tote slots may have a respective lighting element, where the lighting element outputs an indication of the state, presence, etc. of a tote within each tote slot. However, as one or more totes 172 become full, and are removed from third substation 166, the additional lighting elements may output the second indication. One or more sensors 152 of third substation 166 may recognize the lack of presence of one or more totes 172 and subsequently cause the additional lighting elements to output the second indication. Subsequently, this may signify to the associate as to the absence of one or more totes 172 to avoid placing the one or more items into the tote slot once occupied by one or more totes 172. Once a new tote is replaced, and one or more sensors 152 captures the new tote, the additional lighting elements may output the first indication.

In at least one embodiment, third substation 166 may include a fullness mechanism that is used to detect if one or more totes 172 are too full, for example, above a top of one or more totes 172. In some examples, the fullness mechanism may represent a cord, bar, etc. that resides above one or more totes 172. If one or more totes 172 are inducted, but is too full and the one or more items extend above the top of one or more totes 172, the one or more items may contact the fullness mechanism. Item placement module may identify this contact using one or more sensors of third substation 166, and may be used to provide an indication to the associate (e.g., visual, audible, etc.) and/or one or more operations at station 160 may be halted. In other examples, third substation 166 or station 160 may provide visual feedback to the associate that one or more totes 172 are too full, thereby permitting the associate to reorganize and/or redistribute the items.

In at least one embodiment, additional portions or elements of station 160 are described in are described in U.S. patent application Ser. No. 18/604,827 filed Mar. 14, 2024, the entirety of which is herein incorporated by reference and U.S. patent application Ser. No. 17/404,519 filed Aug. 17, 2021, the entirety of which is herein incorporated by reference.

FIG. 2 illustrates system 200 to control sensors and lighting, according to at least one embodiment. System 200 may include sensor module 232, first portion of substation 210, and second portion of substation 220. Sensor module 232 may refer to a module that uses one or more lighting elements that assists one or more sensors to more accurately capture identifiers of items, boxes, or totes described herein. In some examples, first portion of substation 210, and second portion of substation 220 are comprised in second substation 164 illustrated in FIG. 1.

In at least one embodiment, first portion of substation 210 may include a first camera and lighting assemblies 212, and second camera and lighting assemblies 216, where each of the camera and lighting assemblies can include a camera and one or more lighting elements. In some examples, there can be additional camera and lighting assemblies that are not explicitly illustrated in FIG. 2.

In at least one embodiment, each of the camera and lighting assemblies has a FoV, which may at least partially overlap, for creating a volume, area, or space in which the identifier on the item may be identified. As shown, first portion of substation 210 may at least partially hang or extend over second portion of substation 220. In some examples, because some of the camera and lighting assemblies are oriented towards second portion of substation 220, second portion of substation 220 can be anti-reflective coatings to reduce reflections. For example, a lighting subassembly can be disposed beneath piece of glass of second portion of substation 220, where the glass may have anti-reflective coatings.

In at least one embodiment, first camera and lighting assemblies 212 include a camera and lighting element disposed around the camera. For example, the lighting element may represent a ring light (e.g., ring LED) disposed around the camera that outputs light. Similarly, second camera and lighting assemblies 216 include a camera and lighting element (e.g., ring LED) disposed around the camera that outputs light. Additional camera and lighting assemblies may include similar lighting elements.

The camera and lighting subassemblies may include one or more baffles. The lighting elements may be disposed beneath one or more baffles and the one or more baffles may reduce a glare of the lighting elements to the associate. The camera and lighting subassembly may include a housing (e.g., frame, bracket, etc.) that forms the one or more baffles (e.g., louvers). The housing may include a front and a back. The housing may define a channel that extends between the front and the back. The camera may be at least partially disposed through or within the channel, to capture the items, totes, and boxes. The housing may attach to stations (e.g., station 160 illustrated in FIG. 6) in different orientations to provide various FoV.

The lighting elements may be disposed on a printed circuit board (PCB) that couples to the back. The PCB may include a channel for accommodating the camera. The lighting elements may be arranged in a ring around the camera. Any number of the lighting elements (e.g., LEDs) may form the ring. The lighting elements may assist in lighting the environment to enable the camera to capture a set of images of the item. In some examples, the PCB may include the lighting elements, a housing, etc.

In at least one embodiment, the one or more baffles may be oriented in the same direction as one another, or may be oriented in a different direction as one another. A spacing or gap distance is disposed between adjacent baffles to permit light from the lighting elements to shine into the environment. However, the baffles may be angled, titled, etc. to reduce and/or eliminate glare experienced by the associate. For example, as the associate may be working at the station, and facing or orientated towards the lighting elements, the baffles may serve to reduce an amount of glare experienced by the associate. Although a particular orientation or disposition of the baffles are shown, other variations can be envisioned. For example, although the baffles are shown as extending horizontally, in some instances, the baffles may additionally or alternatively extend vertically (e.g., in the Y-direction). In some instances, a depth of the baffles (e.g., in the Z-direction), a spacing between the baffles (e.g., in the Y-direction) and/or an orientation of the camera and lighting subassemblies may be optimized to minimize glare experienced by the associates and/or optimized to maximize an amount of light to illuminate the items.

In at least one embodiment, the baffles may include a planar (e.g., flat) structure, or may include other structures (e.g., sawtooth, ridges, grooves, etc.). In some examples, the baffles may be different than one another, between the housings. Depending upon the location of the camera and lighting assembly, the baffles may be different. The baffles may also be made of a material, or include a surface finish, which reduces the reflections.

In at least one embodiment, sensor module 232 may adjust the intensity, frequency, or temperature of the light emitted by first camera and lighting assemblies 212 and second camera and lighting assemblies 216 to enhance the quality of images captured by first camera and lighting assemblies 212 and second camera and lighting assemblies 216, while also ensuring the safety and comfort of the associates working at the station (e.g., station 160 illustrated in FIG. 1). Sensor module 232 may consider the physical design and placement of the baffles and lighting elements, as well as their positioning relative to the associates, when adjusting the light's intensity, frequency, or temperature. Sensor module 232 may instruct a leading camera and lighting assemblies (e.g., first camera and lighting assemblies 212) at the station to adjust its associated lighting element, with the lighting elements for other cameras (e.g., second camera and lighting assemblies 216) subsequently adjusting in response to the leading camera and lighting assemblies' changes. The leading camera and lighting assemblies may synchronize the light's intensity, frequency, or temperature emitted by other lighting elements at the station. The adjustment can also be based on heights of the associates. The light's intensity, frequency, or temperature can be constant throughout an operation (e.g., unboxing an item, scanning it, and placing it in a tote for storage). The light's intensity, frequency, or temperature can be changed based on the item.

In at least one embodiment, additional portions or elements of system 200 are described in are described in U.S. patent application Ser. No. 18/604,827 filed Mar. 14, 2024, the entirety of which is herein incorporated by reference and U.S. patent application Ser. No. 17/404,519 filed Aug. 17, 2021, the entirety of which is herein incorporated by reference.

FIG. 3 illustrates system 300 to capture items using different sensors, according to at least one embodiment. System 300 may include sensor module 342, item tracking module 344, one or more first sensors 312, one or more second sensors 314 and station (e.g., station 160 illustrated in FIG. 1).

In at least one embodiment, sensor module 342 may refer to a module that controls sensors to obtain information related to an item's movement from one portion (e.g., first substation 162 illustrated in FIG. 1) of the station to another portion (e.g., third substation 166 illustrated in FIG. 1). In some examples, sensor module 342 may control one or more first sensors 312 and one or more second sensors 314. One or more first sensors 312 and one or more second sensors 314 may include cameras, LIDAR, weight sensors, proximity sensors, etc. One or more first sensors 312 may be located in first submodule 162 illustrated in FIG. 1. One or more second sensors 314 may be located in third submodule 166 illustrated in FIG. 1.

In at least one embodiment, one or more first sensors 312 may have FoV 332 that may accommodate boxes of a threshold size (e.g., 4′×4′×4′). Within FoV 332, one or more first sensors 312 may capture a set of images associated with an identifier of the boxes (e.g., one or more boxes 170 illustrated in FIG. 1). An associate within a distribution system may manipulate the boxes on first submodule 162 illustrated in FIG. 1 such that the identifier of the boxes can be identified by item tracking module 344.

In at least one embodiment, item tracking module 344 may refer to a module that tracks the movement of items or any other objects that were previously stored in a box and transferred to a tote for further distribution.

After item tracking module 344 identifies the identifier of the box, information associated with contents of the box (e.g., quantity of item(s), type of item(s), and so forth) can be retrieved and indicated via display. One or more sets of lighting elements may also illuminate FoV 322. For example, a first set of lighting elements and/or a second set of lighting elements may include a distribution field that at least partially overlaps with FoV 322.

Similarly, one or more second sensors 314 may have FoV 334 that may accommodate viewing totes, identifiers on the totes and movements of the items that enter one of the totes. In some instances, FoV 334 may be of a similar or different size as compared to FoV 332. Within FoV 334, one or more second sensors 314 may capture a set of images associated with an identifier of the totes. For example, the identifier may be located on a top surface (e.g., edge, lip, flange, etc.) for being captured by one or more second sensors 314.

Additionally, item tracking module 344 may generate data associated with where the items are placed, such as within which tote the items are deposited based on the set of images generated by one or more second sensors 314. Doing so may allow for the items to be associated with a particular tote, which enables the items to be tracked throughout the environment (e.g., by reading the identifier of the tote). The display within station 160 illustrated in FIG. 1 may present information associated with the tote in which the item is deposited as a result of item tracking module 344 generating determination. A set of lighting elements may illuminate FoV 334.

Item tracking module 344 may cause sensor module 342 to modify, adjust, or otherwise manipulate FoV 332 and the FoV 334 to properly identify boxes, items, and totes described herein. In at least one embodiment, additional portions or elements of system 300 are described in are described in U.S. patent application Ser. No. 18/604,827 filed Mar. 14, 2024, the entirety of which is herein incorporated by reference and U.S. patent application Ser. No. 17/404,519 filed Aug. 17, 2021, the entirety of which is herein incorporated by reference.

FIG. 4 illustrates system 400 to determine whether the items are placed in a location within an environment, according to at least one embodiment. System 400 may refer to be one or more of software and hardware described in conjunction with FIG. 1 to identify whether the items are placed into the environment. System 400 may include one or more first neural networks 402, one or more second neural networks 404, one or more third neural networks 406, and determination module 408.

In at least one embodiment, one or more first neural networks 402 may refer to one or more neural networks described in conjunction with FIG. 1 to identify a region that includes structured identifiers within one or more objects of interest (e.g., one or more items to be placed). One or more first neural networks 402 can include a fully convolutional one-stage object detection architecture. One or more first neural networks 402 may include other convolutional neural networks such as, for example, LeNet, AlexNet, Visual Geometry Group, Inception, ResNet, U-Net, DenseNet, MobileNet, EfficientNet, Capsule Networks, YOLO, Fully Convolutional Network, Regions with Convolutional Neural Networks, V-Net, etc. One or more first neural networks 402 may include feed forward neural networks, recurrent neural networks, long short-term memory networks, autoencoders, generative adversarial networks, transformers, etc. By using first set of images 412, one or more first neural networks 402 can generate bounding boxes and/or confidence scores, where the bounding boxes may indicate regions within first set of images 412 that include structured identifier for the one or more objects of interest.

In at least one embodiment, one or more first neural networks 402 may include a portion that generate indications to first set of images 412, where the indications are directed to the one or more objects of interest. For example, the indications may include (1) label to each pixel that indicates what object or category the pixel belongs to; (2) binary masks that separate the target object from the background; (3) multi-class masks; and (4) boundary and edge maps. Alternatively, the portion is a separate neural network (e.g., convolutional neural network) that generates the indications.

In at least one embodiment, first set of images 412 may refer to one or more images that include items, boxes that include the items, and totes. The one or more images may capture the items located in either the receiving substation (e.g., first substation 162 illustrated in FIG. 1) and/or scanning substation (e.g., second substation 164 illustrated in FIG. 1). The one or more images may capture the boxes located in the receiving substation. The one or more images may capture the totes located in sorting substation (e.g., third substation 166 illustrated in FIG. 3).

In at least one embodiment, one or more first neural networks 402 may include or send predictions (e.g., location of the identifier within images) to a barcode decoder that may refer to a tool to decode one or more structured identifiers contained within the regions identified using one or more first neural networks 402. The barcode decoder can interpret the sequence of lines or patterns according to pre-set standards (such as UPC or QR codes). The barcode decoder can generate or obtain information related to the identified using the structured identifier that was within the one or more objects of interest. The barcode decoder may include any kind of barcode scanning software. Information of one or more objects of interest may include, without limitation, product identification number, batch/lot number, expiration date, serial number, manufacturer information, price information, weight and dimensions, order information, destination data, etc. In some examples, the barcode decoder can be a separate model or a module that is subsequent to one or more first neural networks 402. One or more first neural networks 402 can be trained using training framework 504 illustrated in FIG. 5. One or more first neural networks 402 can be trained by neural network training module 124 illustrated in FIG. 1.

In at least one embodiment, one or more second neural networks 404 may refer to one or more neural networks described in conjunction with FIG. 1 to determine whether one or more objects of interest included in second set of images 414 have properly entered into a container of a set of containers (e.g., totes) placed in the station. One or more second neural networks 404 may include convolutional neural networks such as, for example, LeNet, AlexNet, Visual Geometry Group, Inception, ResNet, U-Net, DenseNet, MobileNet, EfficientNet, Capsule Networks, YOLO, Fully Convolutional Network, Regions with Convolutional Neural Networks, V-Net, etc. One or more second neural networks 404 may include neural networks that performs image segmentation such as, for example, SegNet, DeepLab, PSPNet, RefineNet, etc. Additionally, one or more second neural networks 404 may feed forward neural networks, recurrent neural networks, long short-term memory networks, autoencoders, generative adversarial networks, transformers, etc.

In at least one embodiment, one or more second neural networks 404 may receive a set of images 414 as inputs. Second set of images 414 may refer to one or more images that include the items. The second set of images 414 may capture the items located in the scanning substation. These images are captured within a specific time window to document the movement of items to the scanning substation. Second set of images 414 are captured within the certain time window or time frame such that one or more second neural networks 404 can provide real-time feedback. One or more second neural networks 404 generate real-time feedback to the associates to prevent negative stow events. Negative stow events may refer to issues or errors that occur during the process of placing items into storage, such as totes or shelves. The negative stow events may include misplaced items, overfilled tote, incorrect item orientation, placing damaged items, incorrectly scanned items, stowing incompatible items together, failure to secure fragile items, exceeding weight limits, etc. Determination module 408 may forward real-time feedback received from one or more second neural networks 404 to an associate via a display or lighting element (e.g., a specific light color).

One or more second neural networks 404 can be trained using training framework 504 illustrated in FIG. 5. One or more second neural networks 404 can be trained by neural network training module 124 illustrated in FIG. 1. One or more second neural networks 404 can be trained using ground truth data that indicates various negative stow events as labels.

In at least one embodiment, one or more third neural networks 406 may refer to one or more neural networks described in conjunction with FIG. 1 to confirm whether one or more objects of interest included in second set of images 414 are properly stored in the container of the set of containers placed within the station. One or more third neural networks may include convolutional neural networks, recurrent neural networks, and transformer neural networks.

In at least one embodiment, one or more third neural networks 406 may receive a third set of images 414 as inputs. Third set of images 414 may refer to two or more images that include at least first set of images 412 and second set of images 414. Third set of images 414 may include an item's movement from unpackaging to scanning and placing into the totes. Third set of images 414 may include movement of two or more items that are manipulated by the associate in the station. Determination module 408 may identify which data received from various sensors of the station correspond to the third set of images 414, capturing the entire stow event. One or more third neural networks 406 may generate high-confidence predictions by using third set of images 414 that provides a more holistic view of the associate manipulating the items.

One or more third neural networks 406 can be trained using training framework 504 illustrated in FIG. 5. One or more third neural networks 406 can be trained by neural network training module 124 illustrated in FIG. 1.

In at least one embodiment, determination module 408 may refer to a reasoning function or an orchestration function that determines whether the item is properly stored in a tote. Determination module 408 may generate a data structure that indicates an association between the tote and the item based on the determination. Determination module 408 may communicate with various sensors described herein, allowing different neural networks (e.g., first neural networks 402, second neural networks 404, third neural networks 406) to receive a set of images that can be used to generate predictions. For example, determination module 408 may coordinate various sensors to track the item being manipulated by the associate. Additionally, determination module 408 may ascertain whether the second set of images 414 were captured within a specific time window, ensuring that the second set of images 414 documents the movement of the manipulated item within the sorting station. Also, determination module 408 may synchronize various sensors to ensure that the third set of images 416 captures the entire event (e.g., from unpacking to placing the item into one of the totes). As a result of determination module 408 verifying or confirming a successful stow (e.g., proper and efficient placement of items into totes), determination module 408 may generate a data structure that indicates associations between the tote and the items stored within it.

FIG. 5 illustrates system 500 to train neural networks, according to at least one embodiment. Untrained neural network 506 can be trained using a training dataset 502. Untrained neural network 506 may refer to a neural network architecture that has been initialized but not yet exposed to any training data. Untrained neural network 506 may lack the capability to make accurate predictions or decisions. Training framework 504 can be a PyTorch framework, whereas in other embodiments, training framework 504 can be a TensorFlow, Boost, Caffe, Microsoft Cognitive Toolkit/CNTK, MXNet, Chainer, Keras, Deeplearning4j, or other training framework. Training framework 504 may train an untrained neural network 506 and enables it to be trained using processing resources (e.g., hardware accelerators 224 illustrated in FIG. 2) described herein to generate a trained neural network 508. Determining initial weights of untrained neural network 506 may include performing Zero Initialization, which sets all weights to zero. In other examples, determining initial weights of untrained neural network 506 may include performing one or more of (1) random Initialization, where weights are set to small random values; (2) Glorot Initialization that adjusts the scale of the weights according to the number of input and output neurons; or (3) He Initialization that sets weights with a variance scaled by the number of input neurons. Training may be performed in either a supervised, partially supervised, or unsupervised manner. Also, training may include federated learning, where multiple decentralized devices or servers collaboratively train a model while keeping the training data localized. Untrained neural network 506 may include pre-trained neural networks (e.g., VGG, ResNet, GoogleNet, EfficientNEt, YOLO, BERT, GPT, T5, RoBERTa, XLNet, DeepSpeech, Wav2Vec, Jasper, AlphaZero, StyleGAN, etc).

In at least one embodiment, untrained neural network 506 can be trained using supervised learning, wherein training dataset 502 includes an input paired with a desired output for an input, or where training dataset 502 includes input having a known output and an output of untrained neural network 506 is manually graded. Untrained neural network 506 can be trained in a supervised manner and processes inputs from training dataset 502 and compares resulting outputs against a set of expected or desired outputs. Errors can be propagated back through untrained neural network 506. Training framework 504 can adjust weights that control untrained neural network 506. Training framework 504 may include tools to monitor how well untrained neural network 506 is converging towards a model, such as trained neural network 508, suitable to generating correct answers, such as in result 514, based on input data such as an inferencing dataset 512.

Training framework 504 may train untrained neural network 506 repeatedly while adjusting weights to refine an output of untrained neural network 506 using a loss function and adjustment algorithm, such as stochastic gradient descent. For retraining the trained neural network 508 using the training framework 504, the loss function may include dice loss and adapted dice loss to encourage the trained neural network 508 to generate more conservative prediction by modifying one or more hyperparameters. Training framework 504 may train untrained neural network 506 until untrained neural network 506 achieves a desired accuracy. For example, untrained neural network 506 is evaluated using a test or validation set and the accuracy can be the ratio of correctly predicted labels. In some examples, accuracy of untrained neural network 506 may depend on the final loss on the test or validation set. After determining that the desired accuracy is met, untrained neural network 506 becomes trained neural network 508. Trained neural network 508 can then be deployed to implement any number of machine learning operations. Training neural network 508 may include, for example, one or more first neural networks 402, one or more second neural networks 404, and one or more third neural networks 406 illustrated in FIG. 4.

In some examples, there can be one or more neural networks (separate from untrained neural network 506 and trained neural network 508) that generates training dataset 502. For example, the one or more neural networks may include Generative Adversarial Networks (GANs) or Variational Autoencoders (VAEs) that mimic the characteristics of a genuine dataset. The synthetic images can be accompanied by accurate segmentation maps that label different parts of the image according to predefined categories.

In at least one embodiment, untrained neural network 506 can be trained using unsupervised learning, wherein untrained neural network 506 attempts to train itself using unlabeled data. Unsupervised learning training dataset 502 can include input data without any associated output data or ground truth data. Untrained neural network 506 can learn groupings within training dataset 502 and can determine how individual inputs are related to untrained dataset 502. Unsupervised training can be used to generate a self-organizing map in trained neural network 508 capable of performing operations useful in reducing dimensionality of inferencing dataset 512. Unsupervised training can also be used to perform anomaly detection, which allows identification of data points in inferencing dataset 512 that deviate from normal patterns of inferencing dataset 512.

Semi-supervised learning may be used, which may refer to a technique in which training dataset 502 includes a mix of labeled and unlabeled data. Training framework 504 may be used to perform incremental learning, such as through transferred learning techniques. The incremental learning may enable trained neural network 508 to adapt to inferencing dataset 512 without forgetting knowledge instilled within trained neural network 508 during initial training.

FIG. 6 illustrates process 600 to place items in a location within an environment or move the items within the environment. Although process 600 is depicted as a series of steps or operations, it will be appreciated that at least one embodiment of process 600 includes altered or reordered steps or operations, or omits certain steps or operations, except where explicitly noted or logically required, such as when an output of one step or operation is used as input for another. One or more entities described in conjunction with FIGS. 1-5 and 8, singly or in any combination, can perform each block of process 600. For example, the one or more entities may include computer system 110, one or more processors 120, item tracking module 122, neural network training module 124, sensor module 126, storage 130, hardware accelerators 140, sensors 150, lighting elements 152, illustrated in FIG. 1, sensor module 232 illustrated in FIG. 2, sensor module 342, item tracking module 344 illustrated in FIG. 3, one or more first neural networks 402, one or more second neural networks 404, one or more third neural networks 406, determination module 408 illustrated in FIG. 4, training framework 504, trained neural network 508 illustrated in FIG. 5. The one or more entities may further include, for example, one or more of hardware and/or software described in conjunction with FIG. 1.

Various functions can be carried out by a processor executing instructions stored in memory (e.g., computer-readable, machine-readable) to perform process 600. For example, the instructions may include a computer program persistently stored on magnetic, optical, or flash media. Also, process 600 may be implemented as computer-usable instructions (e.g., macro instruction, micro-instruction) stored on computer storage media or provided by a standalone application, a service, or hosted service (standalone or in combination with another hosted service).

At block 602, the one or more entities may receive a first set of images including a tote (e.g., tote 172 illustrated in FIG. 1, tote 324 illustrated in FIG. 3) to be located within a sorting substation (e.g., third substation 166 illustrated in FIG. 1).

At block 604, the one or more entities may identify, using one or more neural networks (e.g., one or more first neural networks 402 illustrated in FIG. 4), the tote based on the first set of images. Specifically, the one or more entities may identify whether tote slots described in conjunction with FIG. 1 include the tote. If no tote is identified at block 606, process 600 may move to block 602 to identify one or more totes. Prior to moving to block 602, the one or more entities may use a first color, a first intensity of light, a first pattern of light, etc. for signifying to an associate that the tote is present, and therefore, able to be loaded with one or more items. If the tote is identified at block 606, process may move to block 608.

At block 608, the one or more entities may receive a second set of images (e.g., first set of images 412 illustrated in FIG. 4) including an item. The second set of images may include a box (e.g., box 170 illustrated in FIG. 1, box 322 illustrated in FIG. 3) that includes the item and details (e.g., type of items, quantity of items, weight of items, etc.) of the box. The second set of images may include the item being removed from the box and passed over to one or more sensors that captured at least portion of the second set of images.

At block 610, the one or more entities may obtain, using one or more neural networks (e.g., one or more first neural networks 402 illustrated in FIG. 4), information corresponding to the item based on the second set of images. In some embodiments, block 610 may include block 702 illustrated in FIG. 7. The one or more entities may display the characteristics of the item, one or more totes into which the item is to be sorted, and so forth using the information. Prior to using the one or more neural networks, the one or more entities may cause two or more lighting elements to strobe at a common frequency (with or without a phase offset between each lighting element of the two or more lighting elements) based, at least in part, on reducing eye strain for humans and maintaining illumination of the object identified by the one or more neural networks.

At block 612, the one or more entities may determine, using one or more neural networks (e.g., one or more second neural networks 404 and one or more third neural networks 406 illustrated in FIG. 4), whether the item is stored in the tote. The correct tote to store the item can be indicated by the information corresponding to the item. In some embodiments, block 612 may include one or more of block 704, block 706, block 708, block 710, block 712, and block 714 illustrated in FIG. 7.

At block 614, the one or more entities may generate a data structure indicating an association between the item and the tote based on the information and the determination. In some examples, block 614 may include block 714 illustrated in FIG. 7. The data structure can be used to track the item and the tote.

At block 616, the one or more entities may determine whether a threshold has been met for the tote. Specifically, the one or more entities use one or more sensors to determine the threshold based on a percentage full, a fill volume, etc. of the totes. Additionally, or alternatively, the one or more entities may determine the threshold based on the association of the item with the tote, a weight of the item within the tote, and/or a fill of the totes, where those information can be obtained based on the characteristics of the item.

If the threshold has been met at block 618, process 600 may move to block 602 to identify the one or more additional totes. Additionally, the one or more entities may indicate a second color, a second intensity of light, a second pattern of light, etc. to inform the associate that the tote is full. The indication may cause the associate to induct the tote, to refrain from placing one or more additional items into the tote, and/or to replenish a new tote. If the threshold has not been met at block 618, process 600 may move to block 608 to identify the one or more additional items.

In some embodiments, one or more of the operations performed in blocks 602, 604, 606, 608, 610, 612, 614, 616, and 618 may be performed in various orders and combinations, including in parallel.

FIG. 7 illustrates process 700 to determine whether the items are placed in a location within an environment, according to at least one embodiment. Although process 700 is depicted as a series of steps or operations, it will be appreciated that at least one embodiment of process 700 includes altered or reordered steps or operations, or omits certain steps or operations, except where explicitly noted or logically required, such as when an output of one step or operation is used as input for another. One or more entities described in conjunction with FIGS. 1-5 and 8, singly or in any combination, can perform each block of process 700. For example, the one or more entities may include computer system 110, one or more processors 120, item tracking module 122, neural network training module 124, sensor module 126, storage 130, hardware accelerators 140, sensors 150, lighting elements 152, illustrated in FIG. 1, sensor module 232 illustrated in FIG. 2, sensor module 342, item tracking module 344 illustrated in FIG. 3, one or more first neural networks 402, one or more second neural networks 404, one or more third neural networks 406, determination module 408 illustrated in FIG. 4, training framework 504, trained neural network 508 illustrated in FIG. 5. The one or more entities may further include, for example, one or more of hardware and/or software described in conjunction with FIG. 1.

Various functions can be carried out by a processor executing instructions stored in memory (e.g., computer-readable, machine-readable) to perform process 600. For example, the instructions may include a computer program persistently stored on magnetic, optical, or flash media. Also, process 700 may be implemented as computer-usable instructions (e.g., macro instruction, micro-instruction) stored on computer storage media or provided by a standalone application, a service, or hosted service (standalone or in combination with another hosted service).

At block 702, the one or more entities may identify, a structured identifier corresponding to an item (e.g., one or more first neural networks 402 illustrated in FIG. 4). After performing block 702, process 700 may move to block 702 and block 704 simultaneously.

At block 704, the one or more entities may use one or more second neural networks (e.g., one or more second neural networks 404 illustrated in FIG. 4) to generate a first prediction on whether the item is properly stored within the tote, based on a first set of images captured within a short time window (e.g., second set of images 414 illustrated in FIG. 4).

At block 706, the one or more entities may may use one or more third neural networks (e.g., one or more third neural networks 406 illustrated in FIG. 4) to generate a second prediction on whether the item is properly stored within the tote, based on a first set of images captured within a long time window (e.g., third set of images 416 illustrated in FIG. 4).

At block 708, the one or more entities may determine whether the item is stored in the tote based on the first prediction and/or the second prediction. If it is determined that the item is correctly stored in the tote at block 710, process 700 may move to block 712 to identify the one or more additional totes. If the threshold has not been met at block 618, process 600 may move to block 608 to identify the one or more additional items.

At block 712, the one or more entities may generate indications that a negative stow has occurred. In some examples, although not be explicitly illustrated in FIG. 7, process 700 may move to block 706 to further determine that the item is correctly stored as a result of the associate moving the item. In other examples, although not be explicitly illustrated in FIG. 7, process 700 may move to block 702 to scan additional items moved by the associate.

At block 714, the one or more entities may generate associations between the item and the tote. The one or more entities may receive information of the item from the structured identifier associated with the item. The one or more entities may receive information of the tote from a structured identifier associated with the item. After performing block 714, process 700 may move to 702 to scan additional items moved by the associate. In some embodiments, one or more of the operations performed in blocks 702, 704, 706, 708, 710, 712, and 714 may be performed in various orders and combinations, including in parallel.

Any system or apparatus feature described herein may also be provided as a method feature, and vice versa. System and/or apparatus aspects described functionally (including means-plus-function features) may be expressed alternatively in terms of their corresponding structure, such as a suitably programmed processor and associated memory. It should also be appreciated that particular combinations of the various features described and defined in any aspect of the present disclosure can be implemented, supplied, and used independently.

Any system or apparatus feature described herein can include computer programs and computer program products comprising software code adapted, when executed on a data processing apparatus, to perform any of the methods and/or embody any of the apparatus and system features described herein, including any or all of the component steps of any method. Any system or apparatus feature described herein can also include a computer or computing system (including networked or distributed systems) having an operating system that supports a computer program for carrying out any of the methods described herein and/or embodying any of the apparatus or system features described herein. Any system or apparatus feature described herein can also include computer-readable media having stored thereon any one or more of the computer programs aforesaid. Any system or apparatus feature described herein can include a signal carrying any one or more of the computer programs aforesaid.

Note that, in the context of describing disclosed embodiments, unless otherwise specified, the use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

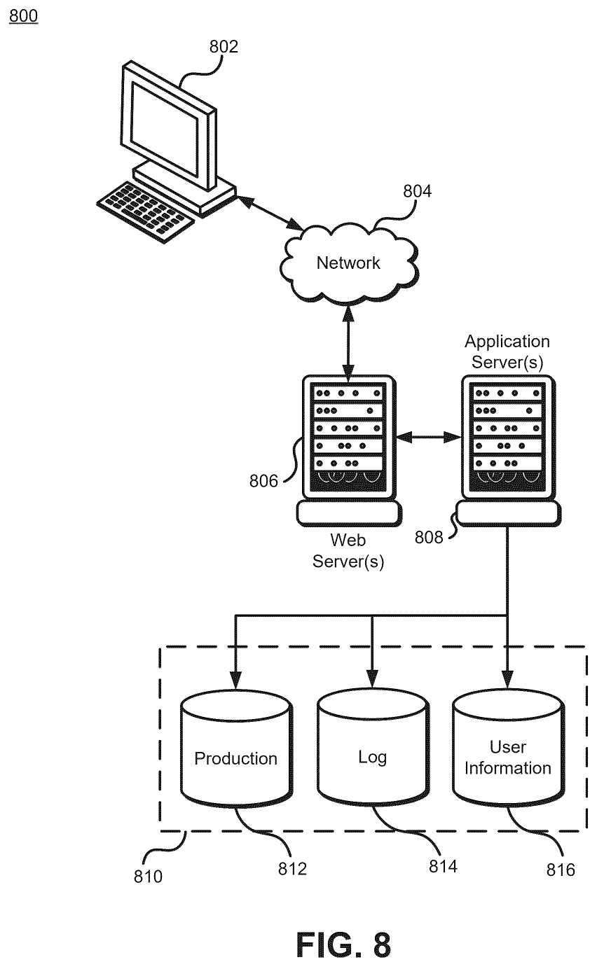

FIG. 8 illustrates aspects of an example system 800 for implementing aspects in accordance with an embodiment. As will be appreciated, although a web-based system is used for purposes of explanation, different systems may be used, as appropriate, to implement various embodiments. In an embodiment, the system includes an electronic client device 802, which includes any appropriate device operable to send and/or receive requests, messages, or information over an appropriate network 804 and convey information back to a user of the device. Examples of such client devices include personal computers, cellular or other mobile phones, handheld messaging devices, laptop computers, tablet computers, set-top boxes, personal data assistants, embedded computer systems, electronic book readers, and the like. In an embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In an embodiment, the network includes the Internet and/or other publicly addressable communications network, as the system includes a web server 806 for receiving requests and serving content in response thereto, although for other networks an alternative device serving a similar purpose could be used as would be apparent to one of ordinary skill in the art.

In an embodiment, the illustrative system includes at least one application server 808 and a data store 810, and it should be understood that there can be several application servers, layers or other elements, processes or components, which may be chained or otherwise configured, which can interact to perform tasks such as obtaining data from an appropriate data store. Servers, in an embodiment, are implemented as hardware devices, virtual computer systems, programming modules being executed on a computer system, and/or other devices configured with hardware and/or software to receive and respond to communications (e.g., web service application programming interface (API) requests) over a network. As used herein, unless otherwise stated or clear from context, the term “data store” refers to any device or combination of devices capable of storing, accessing and retrieving data, which may include any combination and number of data servers, databases, data storage devices and data storage media, in any standard, distributed, virtual or clustered system. Data stores, in an embodiment, communicate with block-level and/or object-level interfaces. The application server can include any appropriate hardware, software and firmware for integrating with the data store as needed to execute aspects of one or more applications for the client device, handling some or all of the data access and business logic for an application.

In an embodiment, the application server provides access control services in cooperation with the data store and generates content including but not limited to text, graphics, audio, video and/or other content that is provided to a user associated with the client device by the web server in the form of HyperText Markup Language (“HTML”), Extensible Markup Language (“XML”), JavaScript, Cascading Style Sheets (“CSS”), JavaScript Object Notation (JSON), and/or another appropriate client-side or other structured language. Content transferred to a client device, in an embodiment, is processed by the client device to provide the content in one or more forms including but not limited to forms that are perceptible to the user audibly, visually and/or through other senses. The handling of all requests and responses, as well as the delivery of content between the client device 802 and the application server 808, in an embodiment, is handled by the web server using PHP: Hypertext Preprocessor (“PHP”), Python, Ruby, Perl, Java, HTML, XML, JSON, and/or another appropriate server-side structured language in this example. In an embodiment, operations described herein as being performed by a single device are performed collectively by multiple devices that form a distributed and/or virtual system.

The data store 810, in an embodiment, includes several separate data tables, databases, data documents, dynamic data storage schemes and/or other data storage mechanisms and media for storing data relating to a particular aspect of the present disclosure. In an embodiment, the data store illustrated includes mechanisms for storing production data 812 and user information 816, which are used to serve content for the production side. The data store also is shown to include a mechanism for storing log data 814, which is used, in an embodiment, for reporting, computing resource management, analysis or other such purposes. In an embodiment, other aspects such as page image information and access rights information (e.g., access control policies or other encodings of permissions) are stored in the data store in any of the above listed mechanisms as appropriate or in additional mechanisms in the data store 810.

The data store 810, in an embodiment, is operable, through logic associated therewith, to receive instructions from the application server 808 and obtain, update or otherwise process data in response thereto, and the application server 808 provides static, dynamic, or a combination of static and dynamic data in response to the received instructions. In an embodiment, dynamic data, such as data used in web logs (blogs), shopping applications, news services, and other such applications, are generated by server-side structured languages as described herein or are provided by a content management system (“CMS”) operating on or under the control of the application server. In an embodiment, a user, through a device operated by the user, submits a search request for a certain type of item. In this example, the data store accesses the user information to verify the identity of the user, accesses the catalog detail information to obtain information about items of that type, and returns the information to the user, such as in a results listing on a web page that the user views via a browser on the user device 802. Continuing with this example, information for a particular item of interest is viewed in a dedicated page or window of the browser. It should be noted, however, that embodiments of the present disclosure are not necessarily limited to the context of web pages, but are more generally applicable to processing requests in general, where the requests are not necessarily requests for content. Example requests include requests to manage and/or interact with computing resources hosted by the system 800 and/or another system, such as for launching, terminating, deleting, modifying, reading, and/or otherwise accessing such computing resources.

In an embodiment, each server typically includes an operating system that provides executable program instructions for the general administration and operation of that server and includes a computer-readable storage medium (e.g., a hard disk, random access memory, read only memory, etc.) storing instructions that, if executed by a processor of the server, cause or otherwise allow the server to perform its intended functions (e.g., the functions are performed as a result of one or more processors of the server executing instructions stored on a computer-readable storage medium).

The system 800, in an embodiment, is a distributed and/or virtual computing system utilizing several computer systems and components that are interconnected via communication links (e.g., transmission control protocol (TCP) connections and/or transport layer security (TLS) or other cryptographically protected communication sessions), using one or more computer networks or direct connections. However, it will be appreciated by those of ordinary skill in the art that such a system could operate in a system having fewer or a greater number of components than are illustrated in FIG. 8. Thus, the depiction of the system 800 in FIG. 8 should be taken as being illustrative in nature and not limiting to the scope of the disclosure.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C#or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

At least one embodiment of the disclosure can be described in view of the following clauses:

1. A computer-implemented method, comprising:
receiving a first portion of a set of images that includes an object of a set of objects that is stored in a container of a set of containers;
identifying, using a first neural network, an identifier corresponding to the object based, at least in part, on the first portion of a set of images;
receiving a second portion of the set of images generated within a time window to include the object moving toward the set of containers;
generating, using a second neural network, a first output that indicates whether the object entered a container of the set of containers based, at least in part, on the second portion of the set of images;
generating, using a third neural network, a second output that indicates whether the object is stored in the container based, at least in part, on the set of images;
generating a confirmation that the object is stored in the container by at least comparing the first output that corresponds to the time window and the second output that corresponds to the set of images; and
in response to generating the confirmation, generating a data structure that indicates associations between the object and the container based, at least in part, on information obtained from the identifier.

2. The computer-implemented method of clause 1, further comprising:
causing a sensor to control a frequency of light for a plurality of sensors, wherein the plurality of sensors are used to generate at least the second portion of the set of images that captures the object from different viewpoints.

3. The computer-implemented method of clause 1 or 2, further comprising:
selecting the container of the set of containers based, at least in part, on the information obtained from the identifier.

4. The computer-implemented method of any of clauses 1-3, further comprising:
determining, using the first neural network, a set of identifiers that corresponds to the set of containers based, at least in part, on a third plurality of images that include the set of containers, wherein at least one of the set of identifiers is usable to obtain additional information to generate the data structure that indicates associations between the object and the container.

5. A system, comprising:
one or more processors; and
memory that stores computer-executable instructions that, if executed, cause the one or more processors to:
identify, within one or more first images, an identifier associated with an object using a first neural network;
as a result of identifying information of the object based, at least in part, on the identifier, generate, using two or more second neural networks, a plurality of predictions on whether the object is stored in a container, wherein the two or more second neural networks use two or more sets of images that are captured within different time frames to generate the plurality of predictions;
determine whether the object is stored in a container based, at least in part, on the plurality of predictions; and
generate an association between the object and the container based, at least in part, on information obtained from the identifier.

6. The system of clause 5, wherein the computer-executable instructions further comprise computer-executable instructions that, if executed by the one or more processors, cause the system to select the container from a plurality of containers based, at least in part, on the information obtained from the identifier.

7. The system of clause 5 or 6, wherein the computer-executable instructions further comprise computer-executable instructions that, if executed by the one or more processors, cause the system to:
cause two or more lighting elements to strobe at a common frequency based, at least in part, on reducing eye strain for humans and maintaining illumination of the object identified by the first neural network.

8. The system of any of clauses 5-7, wherein the computer-executable instructions further comprise computer-executable instructions that, if executed by the one or more processors, cause the system to:
identify, using the first neural network, a set of identifiers that corresponds to the set of containers comprising the container based, at least in part, on a set of images that includes the set of containers, wherein at least one of the set of identifiers is used to obtain additional information to generate the association between the object and the container.

9. The system of any of clauses 5-8, wherein the computer-executable instructions further comprise computer-executable instructions that, if executed by the one or more processors, cause the system to:
determine whether a threshold is met to prevent the container from storing additional objects based, at least in part, on the association between the object and the container.

10. The system of any of clauses 5-9, wherein at least a portion of the two or more sets of images is modified to include time series information.

11. The system of any of clauses 5-10, wherein the plurality of predictions on whether the object is stored in a container comprises one or more class labels and one or more probability scores located within at least a portion of the two or more sets of images.

12. The system of any of clauses 5-11, wherein:
a first neural network of the two or more second neural networks comprises a convolutional neural network; and
a second neural network of the two or more second neural networks comprises a transformer neural network.

13. A non-transitory computer-readable storage medium storing thereon executable instructions that, as a result of being executed by one or more processors of a computer system, cause the computer system to at least:
receive a first set of images including an object;
identify, using a first neural network, an identifier associated with the object based, at least in part, on the first set of first images, wherein the identifier usable to select a tote to store the object;
receive a second set of images including the object, wherein the second set of images is generated within a first time window;
generate, using a second neural network, a first prediction of whether the object entered the tote based, at least in part, on the second set of images;
generate, using a third neural network, a second prediction of whether the object is within the tote based, at least in part, on a third set of images captured within a second time window that is longer than the first time window; and
verify that the object is stored in the tote based, at least in part, on the first prediction and second prediction.

14. The non-transitory computer-readable storage medium of clause 13, wherein the instructions further comprise instructions that, as a result of being executed by the one or more processors, cause the computer system to:
identify, using the first neural network, a set of identifiers that corresponds to a set of totes comprising the tote based, at least in part, on a third set of images, wherein at least one of the set of identifiers is usable to generate an association between the tote and the object.

15. The non-transitory computer-readable storage medium of clause 13 or 14, wherein the instructions further comprise instructions that, as a result of being executed by the one or more processors, cause the computer system to:
in response to the verification, generate an association between the tote and the object based, at least in part, on information obtained from the identifier.

16. The non-transitory computer-readable storage medium of any of clauses 13-15, wherein the identifier comprises a one-dimensional (1D) barcode or a two-dimensional (2D) barcode.

17. The non-transitory computer-readable storage medium of any of clauses 13-16, wherein the third set of images:
is captured to identify movement of the object being manipulated and stored in the tote; and
includes the first set of images and the second set of images.

18. The non-transitory computer-readable storage medium of any of clauses 13-17, wherein the first prediction comprises one or more class labels or one or more probability scores.

19. The non-transitory computer-readable storage medium of any of clauses 13-18, wherein the first neural networks indicates a location of the identifier within at least one of the first set of images.

20. The non-transitory computer-readable storage medium of any of clauses 13-19, wherein:
the first neural network comprises a first convolutional neural network and a decoder;
the second neural network comprises a second convolutional neural network; and
the third neural network comprises a transformer neural network.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A computer-implemented method, comprising:
receiving a first portion of a set of images that includes an object of a set of objects that is stored in a container of a set of containers;
identifying, using a first neural network, an identifier corresponding to the object based, at least in part, on the first portion of a set of images;
receiving a second portion of the set of images generated within a time window to include the object moving toward the set of containers;
generating, using a second neural network, a first output that indicates whether the object entered a container of the set of containers based, at least in part, on the second portion of the set of images;
generating, using a third neural network, a second output that indicates whether the object is stored in the container based, at least in part, on the set of images;
generating a confirmation that the object is stored in the container by at least comparing the first output that corresponds to the time window and the second output that corresponds to the set of images; and
in response to generating the confirmation, generating a data structure that indicates associations between the object and the container based, at least in part, on information obtained from the identifier.

2. The computer-implemented method of claim 1, further comprising:
causing a sensor to control a frequency of light for a plurality of sensors, wherein the plurality of sensors are used to generate at least the second portion of the set of images that captures the object from different viewpoints.

3. The computer-implemented method of claim 1, further comprising:
selecting the container of the set of containers based, at least in part, on the information obtained from the identifier.

4. The computer-implemented method of claim 1, further comprising:
determining, using the first neural network, a set of identifiers that corresponds to the set of containers based, at least in part, on a third plurality of images that include the set of containers, wherein at least one of the set of identifiers is usable to obtain additional information to generate the data structure that indicates associations between the object and the container.

5. A system, comprising:
one or more processors; and
memory that stores computer-executable instructions that, if executed, cause the one or more processors to:
identify, within one or more first images, an identifier associated with an object using a first neural network;
as a result of identifying information of the object based, at least in part, on the identifier, generate, using two or more second neural networks, a plurality of predictions on whether the object is stored in a container, wherein the two or more second neural networks use two or more sets of images that are captured within different time frames to generate the plurality of predictions;
determine whether the object is stored in a container based, at least in part, on the plurality of predictions; and
generate an association between the object and the container based, at least in part, on information obtained from the identifier.

6. The system of claim 5, wherein the computer-executable instructions further comprise computer-executable instructions that, if executed by the one or more processors, cause the system to select the container from a plurality of containers based, at least in part, on the information obtained from the identifier.

7. The system of claim 5, wherein the computer-executable instructions further comprise computer-executable instructions that, if executed by the one or more processors, cause the system to:
cause two or more lighting elements to strobe at a common frequency based, at least in part, on reducing eye strain for humans and maintaining illumination of the object identified by the first neural network.

8. The system of claim 5, wherein the computer-executable instructions further comprise computer-executable instructions that, if executed by the one or more processors, cause the system to:
identify, using the first neural network, a set of identifiers that corresponds to the set of containers comprising the container based, at least in part, on a set of images that includes the set of containers, wherein at least one of the set of identifiers is used to obtain additional information to generate the association between the object and the container.

9. The system of claim 5, wherein the computer-executable instructions further comprise computer-executable instructions that, if executed by the one or more processors, cause the system to:
determine whether a threshold is met to prevent the container from storing additional objects based, at least in part, on the association between the object and the container.

10. The system of claim 5, wherein at least a portion of the two or more sets of images is modified to include time series information.

11. The system of claim 5, wherein the plurality of predictions on whether the object is stored in a container comprises one or more class labels and one or more probability scores located within at least a portion of the two or more sets of images.

12. The system of claim 5, wherein:
a first neural network of the two or more second neural networks comprises a convolutional neural network; and
a second neural network of the two or more second neural networks comprises a transformer neural network.

13. A non-transitory computer-readable storage medium storing thereon executable instructions that, as a result of being executed by one or more processors of a computer system, cause the computer system to at least:
receive a first set of images including an object;
identify, using a first neural network, an identifier associated with the object based, at least in part, on the first set of first images, wherein the identifier usable to select a tote to store the object;
receive a second set of images including the object, wherein the second set of images is generated within a first time window;
generate, using a second neural network, a first prediction of whether the object entered the tote based, at least in part, on the second set of images;
generate, using a third neural network, a second prediction of whether the object is within the tote based, at least in part, on a third set of images captured within a second time window that is longer than the first time window; and
verify that the object is stored in the tote based, at least in part, on the first prediction and second prediction.

14. The non-transitory computer-readable storage medium of claim 13, wherein the instructions further comprise instructions that, as a result of being executed by the one or more processors, cause the computer system to:
identify, using the first neural network, a set of identifiers that corresponds to a set of totes comprising the tote based, at least in part, on a third set of images, wherein at least one of the set of identifiers is usable to generate an association between the tote and the object.

15. The non-transitory computer-readable storage medium of claim 13, wherein the instructions further comprise instructions that, as a result of being executed by the one or more processors, cause the computer system to:
in response to the verification, generate an association between the tote and the object based, at least in part, on information obtained from the identifier.

16. The non-transitory computer-readable storage medium of claim 13, wherein the identifier comprises a one-dimensional (1D) barcode or a two-dimensional (2D) barcode.

17. The non-transitory computer-readable storage medium of claim 13, wherein the third set of images:
is captured to identify movement of the object being manipulated and stored in the tote; and
includes the first set of images and the second set of images.

18. The non-transitory computer-readable storage medium of claim 13, wherein the first prediction comprises one or more class labels or one or more probability scores.

19. The non-transitory computer-readable storage medium of claim 13, wherein the first neural networks indicates a location of the identifier within at least one of the first set of images.

20. The non-transitory computer-readable storage medium of claim 13, wherein:
the first neural network comprises a first convolutional neural network and a decoder;
the second neural network comprises a second convolutional neural network; and
the third neural network comprises a transformer neural network.
